(19) United States
(12) Patent Application Publication
(10) Pub. No.: US 2002/0154528 A1
(43) Pub. Date: Oct. 24, 2002

(54) AC to DC adapter with AC receptacle

(76) Inventor: Avraham Ravid, Herzliya (IL)

Correspondence Address: DR. MARK FRIEDMAN LTD., C/O BILL POLKINGHORN - DISCOVERY DISPATCH, 9003 FLORIN WAY, UPPER MARLBORO, MD, 20772, US

(21) Appl. No.: 09/836,253

(22) Filed: Apr. 18, 2001

(51) Int. Cl. H02M 1/00

(52) U.S. Cl. 363/146

(57) ABSTRACT

An AC-to-DC electrical adapter including a body having a first surface and a second surface, and a pair of electrically conductive blades extending outwardly from the first surface and adapted for inserting into corresponding slots of an alternating current (AC) electrical receptacle. Also comprising the invention is an AC receptacle built into the electrical adapter and accessible at said second surface. Included in the invention is a pair of electrical wires extending from the body of the electrical adapter for conducting DC current, which can be connected to a plurality of plugs, or a plurality of receptacles built into the adapter body for conducting DC current. An AC-to-DC converter is positioned within the body and coupled between the pair of conductive blades and the built-in AC receptacle, wherein when the pair of electrically conductive blades are inserted into corresponding slots of an AC electrical receptacle and the AC-to-DC converter receives an AC electrical voltage from the AC house current receptacle, the AC-to-DC converter is configured to produce at least one DC electrical voltage and to provide at least one DC electrical voltage to the DC electrical wire pair or to the DC receptacles, and the built-in AC receptacle is energized.

### FIELD AND BACKGROUND OF THE INVENTION

The present invention relates to AC to DC adapters and, in particular, it concerns a design in which the AC to DC adapter uses switching circuitry built into a small, lightweight package equipped with a spare AC receptacle. The function provided by the invention is to provide a compact AC to DC adapter that supplies regulated DC power and provides, at the same time, a built-in spare AC socket. This eliminates the need for cumbersome extension arrays and is particularly advantageous where only a single AC socket is available.

Wiring in homes and other buildings has evolved over time to conform to fairly uniform standards. When a consumer in North America purchases an electrically-powered product, he generally does so without concern over its ability to use the electricity supplied by wiring in his house or office. The motors and bulbs in kitchen appliances, office equipment, lamps, power tools, and other electric devices are generally designed to be powered by a 120 V AC supply (i.e.: a supply that delivers alternating current at 60 Hz with a potential of 120 volts RMS). The plugs for these devices and the sockets for the wiring outlets are also standardized. The standardization of these physical features ensures compatibility between the electric power supplies and the devices that use them. Other standards, such as the 220 V AC, 50 Hz system, similarly facilitate the design and use of electrical appliances in other regions of the world.

Many electronic devices, however, require a lower-voltage power source, and direct current instead of AC. To use the available electric power, such as 120 V or 220 V AC, these devices generally use a converter that transforms the available electric power to a lower voltage, rectifies it, and filters it to generate a constant-voltage (DC) supply. The output of the converter is DC at a low voltage, generally between 4 and 30 volts.

The converter may be incorporated into the device as an internal power supply that receives 120 V AC through an electric cord that plugs into a wall socket. Alternatively, the converter may be an external unit as in the present invention, configured as a large wall plug for the device. An external converter generally plugs into a wall socket and supplies low-voltage DC electricity through a power cord. On the other end, the power cord either connects directly to the electronic device or has a plug configured for a socket in the electronic device.

A device that uses an external converter such as the present invention has the advantage of being somewhat lighter and more compact, since the additional circuitry and components necessary for conversion from AC to DC do not have to be incorporated in the device. Thus, the external converters are commonly used with smaller household items such as answering machines, telephones and calculators, among others.

It is known that external AC to DC adapters are often bulky in size as well as heavy, and that they require the provision of an AC socket which is dedicated to supply power to the AC to DC adapter and becomes unavailable for use with other AC electrical devices. When only one socket is available, the user must provide an additional socket for other electrical devices to replace the socket that was occupied by the AC to DC adapter, requiring the use of cumbersome receptacle arrays and extension cords.

The prior art is lacking in disclosure of a compact, lightweight, AC to DC adapter which plugs directly into an AC receptacle while maintaining the connectivity of the AC receptacle. There are various known U.S. patents in which switching technology, a method of reducing voltage in a compact device by high frequency switching, is used to provide a lightweight compact AC to DC adapter. Reference is made to the following U.S. Pat. Nos.: 4,866,585; 5,159,545; 5,161,098; 5,245,220; 5,563,782; 6,061,261 and 6,160,728. However, none of the above provide a built-in AC socket to maintain AC connectivity to the house wiring at the point of the use.

In U.S. Pat. No. 5,161,098 there is described an AC to DC adapter in the shape of a compact plug-in module which uses switching technology to eliminate the need for a step-down transformer, thus permitting a significant reduction in the size of the device. In U.S. Pat. No. 5,563,782, the invention is an AC to DC adapter in the form of a duplex wall receptacle having a plurality of AC receptacles which uses switching technology. In U.S. Pat. No. 6,160,728, the invention is a compact AC to DC adapter which plugs into one socket of a typical duplex AC receptacle without interfering with the adjacent socket, like prior art DC conversion systems. However, neither the latter patent nor any of the above patents comprises the inventive feature of providing a compact plug-in type AC to DC adapter with a built-in AC receptacle designed and configured to maintain AC connectivity to the house wiring at the point of the use.

There is therefore a recognized need for, and it would be highly advantageous to have a plug-in type AC to DC adapter which reduces the need to provide cumbersome receptacle arrays and extension cords by providing a built-in spare AC receptacle to power other electrical devices.

### SUMMARY OF THE INVENTION

Described herein is an AC/DC adapter that receives high-voltage alternating current (such as 120 V or 240 V AC) from electrical wiring in a building and uses switching technology to provide low-voltage direct current (including 3, 4.5, 6, 9 or 12 V DC), while providing a spare AC receptacle built-into the device to maintain the connectivity of the building AC receptacle. The adapter thereby provides AC connectivity for other electrical devices while simultaneously providing low voltage DC power. The adapter has input pin terminals configured for connecting to the building's wiring that plug into a standard electrical socket, and it includes an AC-to-DC converter that generates the low-voltage direct current from the high-voltage alternating current.

In one embodiment of the invention, multiple plugs affixed to the end of an electrical cord connected to the output terminal of the DC power supply printed circuit board and protruding from the body of the AC to DC adapter can be used to provide the low-voltage DC to virtually any configuration of electronic device power input receptacle.

According to further features in the described preferred embodiments, one or more switches may be used to select the DC voltage level delivered by the DC output cable.

In another preferred embodiment of the invention, there is provided an AC to DC adapter with DC miniature sockets to allow the connection of conductive prongs to meet DC power connectivity requirements of virtually any electronic device.

The present invention successfully addresses the shortcomings of the existing technologies by providing an AC to DC adapter which is small, lightweight, versatile, and incorporates an AC socket in the body of the device to maintain AC connectivity with the house wiring at the point of use. This eliminates the need to utilize cumbersome multiple receptacle arrays and extension cords to provide the connectivity of AC electrical devices.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is an isometric side view showing an AC to DC adapter comprising one embodiment of the invention;

FIG. 2 is a view of the component parts of the AC to DC adapter comprising one embodiment of the invention;

### DESCRIPTION OF THE PREFERRED EMBODIMENTS

The present invention is an AC to DC adapter which uses standard switching technology to provide a small lightweight, inexpensive to manufacture device for supplying low voltage DC current to power small electrical devices. Standard switching technology is used in the invention to accomplish the conversion of high voltage AC power to low voltage DC current, as described, for example, in U.S. Pat. No. 5,161,098 (Balakrishnan, 1992), which is incorporated by reference herein for all purposes as if fully set forth herein.

The principles and operation of the AC to DC adapter according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting

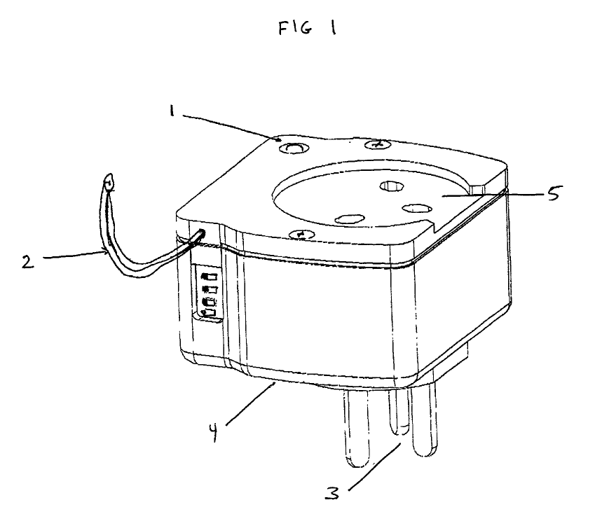

Referring now to the drawings, FIG. 1 is an isometric side view showing an AC to DC adapter comprising one embodiment of the invention. In the figure, the DC electrical wire pair 2 is shown protruding form the body 4 of the AC to DC adapter, according to one preferred embodiment of the invention. In another preferred embodiment of the invention, the DC electrical wire pair 2 is replaced by one or more DC receptacles (not shown), which are built into the body of the AC to DC adapter and are designed and configured to be compatible with commonly available DC plugs of electrical devices. In another preferred embodiment of the invention, the DC wire pair is terminated at the end by a plurality of DC plugs of different configurations. Also shown in FIG. 1 are conductive prongs 3 designed to be inserted in the common house wiring AC receptacle. AC receptacle 5 is built into the overall assembly 4 of the AC to DC adapter and provides AC connectivity at the point of insertion of the AC to DC adapter. Finally, shown in FIG. 1 is LED 1 which, when lit, indicates the proper functioning of the AC to DC adapter.

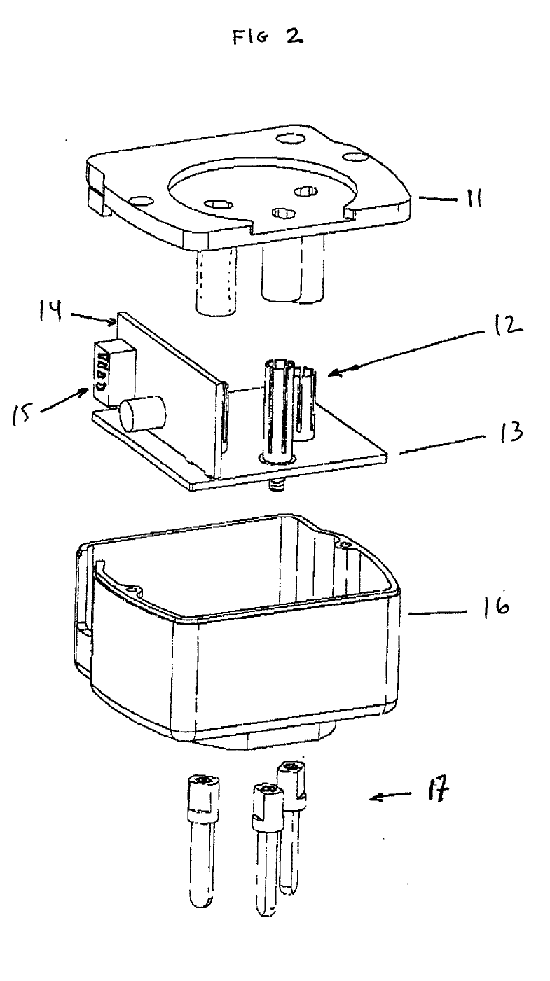

FIG. 2 is an “exploded” view of AC to DC adapter showing the main component parts comprising one embodiment of the invention. In the figure, three conductive pins 17 are shown in position adjacent to the bottom of body 16 of the AC to DC adapter. Printed circuit boards 13 and 14 containing the electronic circuitry which performs the function of rectifying the AC current to DC and the voltage reduction step using switching technology, fit into the bottom and side surfaces of the body 16, respectively. Printed circuit board 13 contains the electronic components which convert AC voltage to DC using standard switching technology. Printed circuit board 14 contains the electronic components which control the switching rate, thereby providing the means to regulate the output DC voltage level. DC voltage selector switch 15 is attached to the printed circuit board 14 for selection by the user of one of several available DC voltages, such as 3, 4.5, 6, 9, or 12 VDC. Control of the output voltage is accomplished by various switch configurations which can provide these output voltages. The small size of electronic components utilized and hence of printed circuit boards 13 and 14 and their unique juxtaposition as provided in this embodiment of the invention allow for the inclusion of an AC receptacle in the body of the AC to DC adapter itself. Three threaded conductive plugs 12 comprising the built-in AC receptacle of the electrical adapter are screwed in to the three threaded conductive pins 17, thereby providing electrical connectivity of the built-in AC receptacle to the AC house wiring. Cover plate 11 supporting LED 1 and containing holes for fastening screws as well as for the three electrical conducting pins 12 comprising the built-in AC receptacle, is shown as it would be assembled at the top of the electrical adapter. Conductive plugs 12 and 17 can be configured in various different geometric forms to comply with specific electrical protocols in virtually any country. Further, because switching technology is used for converting AC voltage to DC voltage, the adapter can be used with virtually any commonly available AC house wiring voltage such as 110 VAC or 220 VAC.

The specific embodiment of the invention that has been described envisions the provision of a single AC receptacle in the body of the AC to DC adapter. A further embodiment of the invention is envisioned in which the AC to DC adapter provides multiple AC receptacles housed in a single longer body, which is plugged directly into the AC house wiring receptacle. A further embodiment is envisioned in which the single or multiple-receptacle version of the AC to DC adapter is connected to the AC house wiring using a cable connected to an AC plug.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broadscope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An electrical adapter comprising:
(a) a body having a first surface and a second surface,
(b) a pair of electrically conductive blades extending outwardly from the first surface and configured for inserting into corresponding slots of an alternating current (AC) electrical receptacle,
(c) a pair of electrical wires extending from said body of the electrical adapter for conducting direct current (DC),
(d) an AC-to-DC converter positioned within the body and connected to the pair of conductive blades, wherein when the pair of electrically conductive blades are inserted into corresponding slots of an AC electrical receptacle and the AC-to-DC converter receives an AC electrical voltage from the AC receptacle via the pair of conductive blades, the AC-to-DC converter is configured to produce at least one DC electrical voltage and to provide at least one DC electrical voltage to the DC electrical wire pair.
(e) an AC receptacle built into the electrical adapter, accessible at said second surface, and connected to said pair of electrically conductive blades.

2. The electrical adapter of claim 1, wherein the body is dimensioned such that when the pair of electrically conductive blades are inserted into one of two or more AC electrical receptacles of a duplex or multiple AC electrical receptacle, the other AC electrical receptacles of the duplex or multiple AC receptacle are accessible.

3. The electrical adapter of claim 1, wherein the electrical adapter is portable and may be moved from one AC electrical receptacle to another AC electrical receptacle.

4. The electrical adapter of claim 1, wherein said AC-to-DC converter is configurable to generate a selected one of a plurality of DC electrical voltages.

5. The electrical adapter of claim 1, wherein the adapter body is dimensioned to to contain a plurality of AC receptacles, and wherein a plurality of AC receptacles are connected in parallel to the pair of electrically conductive blades.

6. An electrical adapter comprising:
(a) a body having a first surface and a second surface,
(b) a pair of electrically conductive wires extending outwardly from said body and connected to a pair of electrically conductive blades which are configured for inserting into corresponding slots of an alternating current (AC) electrical receptacle,
(c) a pair of electrical wires extending from said body of the electrical adapter for conducting direct current (DC),
(d) an AC-to-DC converter positioned within the body and connected to the pair of conductive blades, wherein when the pair of electrically conductive blades are inserted into corresponding slots of an AC electrical receptacle and the AC-to-DC converter receives an AC electrical voltage from the AC receptacle via the pair of conductive blades, the AC-to-DC converter is configured to produce at least one DC electrical voltage and to provide at least one DC electrical voltage to the DC electrical wire pair.
(e) an AC receptacle built into the electrical adapter, accessible at said second surface, and connected to said pair of electrically conductive blades.

7. The electrical adapter of claim 1, wherein said AC to DC converter further comprises
(f) a third electrically conductive blade extending outwardly from the first surface and configured for inserting into the ground slot of an alternating current (AC) electrical receptacle, wherein said AC receptacle built into the electrical adapter, accessible at said second surface, is connected to said pair of electrically conductive blades and to said third electrically conductive blade.

8. The electrical adapter of claim 1, wherein said AC-to-DC converter is configured to generate a plurality of DC electrical voltages, and wherein the electrical adapter further comprises:
(g) a switch coupled to said AC-to-DC converter and to said DC electrical socket, wherein said switch receives the plurality of DC electrical voltages and provides a selected one of the plurality of DC electrical voltages to the pair of electrical wires extending from said body of the electrical adapter for conducting direct current, dependent upon the position of the switch.

9. The electrical adapter of claim 8, wherein said AC-to-DC converter is configured to receive AC electrical voltage in the range of 90 V to 280 V.

10. The electrical adapter of claim 8, wherein said AC-to-DC converter is configured to produce the at least one DC electrical voltage in the range of 0.5 V to 30 V.

11. The electrical adapter of claim 8, wherein the first and second surfaces are substantially planar.

12. The electrical adapter of claim 8, wherein the first and second surfaces are on opposite sides of the body.

13. The electrical adapter of claim 8, wherein the body has six surfaces, and wherein the first and second surfaces are two of the six surfaces of the body.

14. The electrical adapter of claim 8, wherein one or more plugs are connected to said pair of electrical wires extending from said body of the electrical adapter for conducting direct current (DC).

15. The electrical adapter of claim 8, wherein said AC-to-DC converter contains a plurality of AC receptacles connected in parallel to the pair of electrically conductive blades.

16. An electrical adapter comprising:
(a) a body having a first surface and a second surface,
(b) a pair of electrically conductive blades extending outwardly from the first surface and adapted for inserting into corresponding slots of an alternating current (AC) electrical receptacle,
(c) one or more direct current (DC) receptacles built into the body of said electrical adapter for conducting direct current by connecting the conductive plug or plugs of one or more electric devices,
(d) an AC-to-DC converter positioned within the body and connected to the pair of conductive blades, wherein when the pair of electrically conductive blades are inserted into corresponding slots of an AC electrical receptacle and the AC-to-DC converter receives an AC electrical voltage from the AC receptacle via the pair of conductive blades, the AC-to-DC converter is configured to produce at least one DC electrical voltage and to provide at least one DC electrical voltage to the DC electrical wire pair, and
(e) an AC receptacle built into the electrical adapter and accessible at said second surface.

17. The electrical adapter of claim 16, wherein the body is dimensioned such that when the pair of electrically conductive blades are inserted into one of two or more AC electrical receptacles of a duplex or multiple AC electrical receptacle, the other AC electrical receptacles of the duplex or multiple AC receptacle are accessible.

18. The electrical adapter of claim 16, wherein the electrical adapter is portable and may be moved from one AC electrical receptacle to another AC electrical receptacle.

19. The electrical adapter of claim 16, wherein said AC-to-DC converter is configurable to generate a selected one of a plurality of DC electrical voltages.

20. The electrical adapter of claim 16, wherein said AC-to-DC converter contains a plurality of AC receptacles connected in parallel to the pair of electrically conductive blades.

21. The electrical adapter of claim 20, wherein said AC to DC converter further comprises
(f) a third electrically conductive blade extending outwardly from the first surface and configured for inserting into the ground slot of an alternating current (AC) electrical receptacle, wherein said AC receptacle built into the electrical adapter, accessible at said second surface, is connected to said pair of electrically conductive blades and to said third electrically conductive blade.

22. The electrical adapter of claim 16, wherein said AC-to-DC converter is configured to receive AC electrical voltage in the range of 90 V to 280 V.

23. The electrical adapter of claim 16, wherein said AC-to-DC converter is configured to produce the at least one DC electrical voltage in the range of 0.5 V to 30 V.

24. The electrical adapter of claim 16 wherein the first and second surfaces are substantially planar.

25. The electrical adapter of claim 22, wherein the first and second surfaces are on opposite sides of the body.

26. The electrical adapter of claim 22, wherein the body has six surfaces, and wherein the first and second surfaces are two of the six surfaces of the body.
